(19) United States
(12) Patent Application Publication
(10) Pub. No.: US 2012/0293329 A1
(43) Pub. Date: Nov. 22, 2012

(54) WIRELESS DOG BARKING ALARM SYSTEM

(76) Inventors: James Vernon CUNNINGHAM, Aurora (CA); Mircea Dan PAUL, Richmond Hill (CA); Timothy James Hendrie POUPORE, Toronto (CA); Stacey Charleen GAY, Toronto (CA); Leo RALPH, Markham (CA)

(21) Appl. No.: 13/112,083

(22) Filed: May 20, 2011

(51) Int. Cl. G08B 13/16

(52) U.S. Cl. 340/566

(57) ABSTRACT

The present invention is an alarm system that includes at least one base unit operable to detect sound levels and to transmit a signal to cause an alarm response, such as emission of media that may be the sound of one or more dog barks. The media may be emitted through one or more applicable broadcasting device, such as through a speaker, and may be the sound of one or more dog barks. The broadcasting device and base units may be configured to function collectively to create a realistic deterrent effect. Other alarm responses may be part of the system, such as electronic device warning messages, turning on a light, etc. The alarm responses and the general operation of the system may be set by a user, either through the base unit or by other remote input means (e.g., a fob unit or other electronic device).

### FIELD OF INVENTION

This invention relates in general to the field of an alarm system and more particularly to a wireless alarm system that is operable to emit the sound of one or more dogs barking to deter intruders.

### BACKGROUND OF THE INVENTION

The use of alarm systems is known in the prior art. More specifically, prior art alarm systems are known to consist basically of familiar, expected and obvious structural configurations. Known prior art alarm systems include: U.S. Pat. No. 7,683,800; U.S. Pat. No. 7,522,035; U.S. Pat. No. 7,403,110; U.S. Pat. No. 7,268,689; U.S. Pat. No. 7,265,658; U.S. Pat. No. 7,170,404; U.S. Pat. No. 4,571,583; U.S. Pat. No. 4,544,920; U.S. Pat. No. 4,074,247; U.S. Pat. No. 4,131,887; U.S. Pat. No. 4,212,007; U.S. Pat. No. 3,740,737; U.S. Pat. No. 5,450,063; U.S. Pat. No. 4,646,343; U.S. Pat. No. 4,835,520; U.S. Pat. No. 3,938,120; U.S. Pat. No. Des. 334,930; U.S. Patent Application Publication No. 2010/0188212; U.S. Patent Application Publication No. 2010/0185406; and U.S. Patent Application Publication No. 2009/0201160.

In particular, U.S. Pat. No. 4,571,583 and U.S. Pat. No. 4,544,920 disclose utilizing detected noise to activate prerecorded sounds of a menacing dog to scare away intruders. However, these patents do not disclose a way to determine whether the detected noise is that of a potential intruder or an innocent ambient noise. Consequently the alarms disclosed in these patents will be needlessly sounded in many instances. Moreover, the alarms disclosed in these patents provide for the emission of only a single recorded dog sound and are not able to be tailored to the preferences, or the situation, of a user of the alarm.

In regards to U.S. Pat. No. 7,683,800, the invention disclosed in this patent is a doorbell notification system whereby when the doorbell is pushed the sound of dog barking may be projected through the speakers. The patent also discloses that a wireless transmitter may be activated by a user pushing a doorbell to cause the sound of electronic dog barking to be projected through a speaker. The patent further discloses that a panic button may be pushed to cause the electronic dog barking to be projected through a speaker. This invention therefore causes dog barking to be projected through a speaker upon the specific sound of the doorbell being recognized by the system, or upon the push of a panic button.

U.S. Pat. No. 7,170,404 discloses an alarm system that is activated by the unit detecting specific sounds that it is programmed to recognize. When activated the system will take programmed measures to wake a user. As an example, this patent discloses that if the sound of a building security alarm, a fire alarm, or a health indicating alarm is recognized by the system then it will activate the measures to wake the user. Therefore, this patent discloses an invention that is only operable to recognize specific sounds.

### SUMMARY OF THE INVENTION

In one aspect, the present disclosure relates to an alarm system, comprising: a noise detection means operable to detect one or more noises; at least one comparator operable to compare the detected one or more noises to a reference sound level and determine if the one or more noises are equal to or exceed the reference sound level; and at least one base transceiver operable to transmit one or more signals to one or more alarm response devices if the comparator determines the one or more noises are equal to or exceed the reference sound level, said base transceiver transmitting the one or more signals wirelessly or through a wired connection; the one or more alarm response devices each being operable to produce an alarm response.

In another aspect, the present disclosure relates to a method of producing one or more alarm responses by one or more alarm response devices, comprising the steps of: a noise detection means linked to a base unit detecting a noise; a comparator contained in the base unit comparing the detected noise to a reference sound level; a base transceiver contained in the base unit transmitting one or more signals to at least one of the one or more alarm response devices when the comparator determines that the detected noise is equal to or exceeds the reference sound level; and the at least one of the one or more alarm response devices receiving the one or more signals and producing the one or more alarm responses in response to receipt of the one or more signals.

In yet another aspect, the present disclosure relates to an alarm system, comprising: two or more base units incorporating: a noise detection means operable to detect one or more noises; at least one comparator operable to compare the detected one or more noises to a reference sound level and determine if the one or more noises are equal to or exceed the reference sound level; and at least one base transceiver operable to transmit one or more signals to one or more alarm response devices if the comparator determines the one or more noises are equal to or exceed the reference sound level, said base transceiver transmitting the one or more signals wirelessly or through a wired connection; and the one or more alarm response devices, each of the one or more alarm response devices being associated with one of the two or more base units, and each of the one or more alarm response devices being operable to produce an alarm response.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1A is a perspective front view of a base unit with the hinged cover section in an open position.

FIG. 1B is a perspective front view of a base unit with the hinged cover section in a closed position.

FIG. 2 is a view of an embodiment of the present invention incorporating a base unit that is operable to transmit a signal to a speaker.

FIG. 3 is a view of an embodiment of the present invention incorporating multiple base units operable to transmit signals to a speaker.

FIG. 4 is a view of an embodiment of the present invention incorporating a base unit that is operable to transmit signals to multiple speakers.

FIG. 5 is a view of an embodiment of the present invention incorporating multiple base units operable to transmit signals to multiple speakers.

FIG. 6 is a perspective front view of a key fob.

FIG. 7 is a view of an embodiment of the present invention incorporating a key fob operable to communicate with the base unit.

FIG. 8 is a view of an embodiment of the present invention incorporating a base unit operable to communicate with multiple elements, including a speaker, a lamp and a cellular phone.

FIG. 9 is a view of an electric circuit of an embodiment of a base unit that may be useable with the present invention.

FIG. 10 is a view of an electric circuit of an embodiment of a speaker that may be useable with the present invention.

In the drawings, embodiments of the invention are illustrated by way of example. It is to be expressly understood that the description and drawings are presented only for the purpose of illustration and as an aid to understanding the present invention. The description and drawings are not intended as a definition of the limits of the invention.

### DETAILED DESCRIPTION OF THE PREFERRED EMBODIMENT

The present invention is an alarm system that includes a base unit incorporating a sound detection means that is operable to detect sounds and to transmit a signal to cause an alarm response should a sound that is detected exceed a specified reference sound level. The alarm response may be the emission of media, for example, such as the sound of one or more dog barks. The media may be emitted through an applicable broadcasting device, such as through a speaker if the media is the sound of one or more dog barks. Other alarm responses may also be integrated with the present invention, such as warning messages sent to a telephone or electronic device, or a light that is turned on when a signal is transmitted, a siren, a strobe light, or other alarm responses. The alarm responses and the operation of the system may be set by a user, either through the base unit (such as by way of entry using a keypad, or other input means) or by other remote input means, such as by way of a key fob unit or other electronic device. The alarm responses may have the effect of deterring a potential intruder and some alarm responses may further act as a warning to persons in a building, or persons remote from the building, of the presence of a possible intruder in or near the building.

As an example, if the present invention is being used to detect noises that indicate an intruder trying to gain access to a building, the base unit may be positioned inside the building, or on the exterior of the building. For example, the base unit could be positioned near to a door or a window of the building. The base unit may also be positioned in another location near the building. The base unit may be attached, either permanently or removeably, to a building, structure or other support in its position, or may be positioned in a manner whereby it is unattached.

For the purpose of this document, the term “building” may refer to a house, an apartment unit, an apartment building, a structure, an office unit, an office building, or any other type of building or structure of any size or type.

The present invention alarm system may include a sound detection means that detects sounds and compares the detected sounds to a specified reference sound level to determine if the sound is equal to or exceeds the specified reference sound level. The sound detection means may be incorporated into the base unit, or otherwise integrated with the base unit. Should a sound detected by the sound detection means be equal to, or exceed, the reference sound level then subsequently one or more signals may be transmitted from the base unit to other elements of the present invention, such as one or more broadcasting devices, or other devices, as described herein.

The transmission of the one or more signals may cause one or more alarm responses to occur. For example, the alarm responses may include emission of sound through a speaker (such as dog(s) barking), the emission of light through a lamp, communication of an intruder warning communication to an electronic device, a buzzer sounding, a siren sounding, emission of sound through a radio or television, emission of sound that is a recording of a person speaking or another type of recorded sound, or other alarm responses. The alarm system of the present invention may include one or more sound detection means and one or more alarm responses and associated devices.

In embodiments of the present invention a single alarm response may occur upon the detection of noise that is equal to or greater than the set noise level, or multiple alarm responses may occur. As described herein, it may further be possible for embodiments of the present invention to trigger or activate one or more alarm responses even if a noise that is equal to or greater than the sound level is not detected, such as by pressing a panic button on a key fob.

The alarm system may function in accordance with instructions received through direct input to the alarm unit or instructions provided to the alarm system by a remote device. In embodiments of the present invention direct input may be achieved through a keypad incorporated or connected to the base unit, or other input means that is incorporated in or connected to the base unit. Remote devices may be used to provide instructions (via a signal or other communication) and such remove devices may include, for example, a key fob, a cellular phone, a tablet, a smart phone, or another electronic device. The function of the system may be controlled by one or more controllers (such as microcontrollers or other controllers), and at least one controller may be incorporated into the base unit as a base controller.

The elements of the alarm system may be connected through direct wired connections, or by wireless connections. A skilled reader will recognize the various configurations of the present invention that may be possible wherein various elements are either connected through direct wiring or wirelessly, for example, some elements may be connected through direct wiring and other elements may be connected wirelessly, or all elements may be connected through direct wiring or wirelessly.

This application will make reference to the present invention being positioned near a building and being used to detect possible intruders to a building. However, a skilled reader will recognize that the present invention may be utilized in other environments to detect noises for other purposes.

This application will make reference to the present invention utilizing broadcasting devices that are speakers to emit sounds that are dog barking sounds. This embodiment of the present invention is referenced for the sake of providing one example of an embodiment of the present invention. However, the present invention is not limited to this referenced embodiment. A skilled reader will recognize that embodiments of the present invention may include a variety of broadcasting devices, that may or may not be speakers, and that the broadcasting devices may emit media that are sounds or other types of media. A skilled reader will further recognize that embodiments of the present invention may function to emit many types of media, which may include sound recordings, and that this media may include or may not include sound recordings of dog barking.

The present invention provides certain benefits and advantages over known prior art alarm systems. Prior art alarm systems are programmed to detect and recognize specific sounds, such a doorbell or a fire alarm, etc. The present invention may be operable to detect a noise level rather than specific sounds. As a consequence the present invention may be utilized to trigger an alarm upon instances when a noise level indicates an intruder, but a specific noise is not necessarily sounded, therefore the present invention may trigger an alarm upon instances that the prior art alarm systems cannot recognize as a possible intruder circumstance.

Additionally, the noise level to be detected by the present invention may be programmed to vary at different date and time combinations, as described herein. Therefore, the present invention may not be needlessly activated or triggered by a specific type of reoccurring noise, as is the likely outcome of the use of the prior art. The present invention may be triggered or activated by noise that meets a reference level that may be set for a specific period of time. Consequently, the application of the present invention may be flexible to accommodate occasions when reoccurring noises may be likely take place and when noise of a certain level may occur, so that these instances which are known to not be indications of an intruder attempting to gain unlawful access to a building will not activate or otherwise trigger the alarm of the system of the present invention. For example, if glass is to be broken due to construction in a building, a prior art alarm system that responds to the specific noise of glass breaking will be triggered by the construction noise, or will need to be turned off during the construction. The alarm of the present invention system is not triggered or activated by specific types of noise, therefore the reference level could be set to accommodate the construction noises during the time period of the construction, and still detect noises that may indicate a possible intruder. A user of the present invention would not necessarily be required to turn off the system during the construction period, so that the building could remain protected during the construction period. A skilled reader will recognize the advantages that the present invention offer over the prior art due to function of the present invention to detect noise levels and to compare these to a reference sound level before triggering or activating an alarm.

Another benefit of the present invention over the prior art, is that some prior art alarm systems function to detect motion. The present invention detects sound and may trigger an alarm based upon the level of the sound. Therefore, the present invention may trigger an alarm to deter an intruder before the intruder is within the range to be recognized by a motion detector. This may mean that the present invention may trigger an alarm before an intruder is already gaining access to a building. Consequently, the alarm of the present invention may deter a potential intruder from moving any closer to the building.

Yet another benefit of the present invention over the prior art is that, some prior art alarm systems merely function to sound a single form of alarm and the alarm may sound at a specific level. The present invention may be operable to activate one or more forms of alarms. For example, the present invention may be operable to activate one or more speakers to emit the sound of one or more dogs barking. The speakers may be positioned in a manner whereby the barking sounds indicate multiple dogs within the building. The emitted sound may further be programmed to fade and grow, so as to imitate the movement of a dog within the building. This may create a more realistic effect of one or more live dogs being within the building, which should provide a greater deterrent to potential intruders than is posed by known prior art alarm systems. Additionally, the present invention may be operable to cause multiple alarm responses to occur in a manner that may further suggest that both one or more dogs and at least one human is inside the building. For example, the present invention may cause one or more speakers to emit the sounds of one or more dogs barking, and a lamp to light in the building, as if in response to a person moving in response to the dog bark or the sound of the potential intruder.

Still another benefit of the present invention over the prior art is that some prior art alarm systems require wired connections between elements, such as a noise detector and a speaker that emits an alarm. This creates a need for elements to be in close range to one another, or for a substantial amount of wiring to be strung within a building. Excess wiring diminishes the aesthetic of a building and can be a hazard (e.g. the wire can be tripped over, can be a hazard for children in the building, etc.). Moreover, the requirement to have the noise detector and any speakers in the system in close range can diminish the possible realistic effect that the sound emitted by the speakers, such as barking dog noises, may create in the building. The present invention provides a benefit in that the sound detector and speakers may interact wirelessly and consequently may be positioned at a variety of distances from one another without the hazard created by wiring. Placement of speakers at a distance from the noise detector may create a realistic illusion of at least one dog located within the building. Moreover, the freedom to place speakers virtually anywhere in the building can allow for multiple speakers to be positioned at a variety of locations in the building. These speakers may be wirelessly connected to one or more sound detectors, so that the illusion of more than one dog in the building, or a dog moving in the building, may be created by the sound of barking or movement of a dog emitted through the one or more speakers. In general, the present invention offers the benefit of offering the possibility of creating a more realistic or life-like sound of one or more dogs within the building, and consequently may create a greater deterrent for would-be intruders.

The present invention incorporates U.S. Pat. No. 5,886,631 by reference. U.S. Pat. No. 5,886,631 discloses a barking dog sound alarm system construction wherein the same can be utilized for scaring away intruders using the menacing sounds of a dog. The invention disclosed in U.S. Pat. No. 5,886,631 generally comprises a microphone for detecting noise, a device to compare the detected noise level to a reference level so as to determine whether the detected noise is a potential intruder, a plurality of sound recordings of different dogs, a speaker for broadcasting one or the recordings, and a controller for activating one of the sound recordings when the detected noise is determined to be a potential intruder. The elements of the invention disclosed in U.S. Pat. No. 5,886,631 are connected through a circuitry described in the patent document.

The present invention further may comprise wireless interaction between the elements of the present invention as well as additional elements incorporated in embodiments of the invention, as described herein. In particular the present invention may wirelessly transmit a signal to a broadcasting device, for example, such as one or more speakers. Upon receipt of the signal the broadcasting device may emit media, for example, such as sound recordings of the sound of one or more dogs barking may be projected through the one or more speakers.

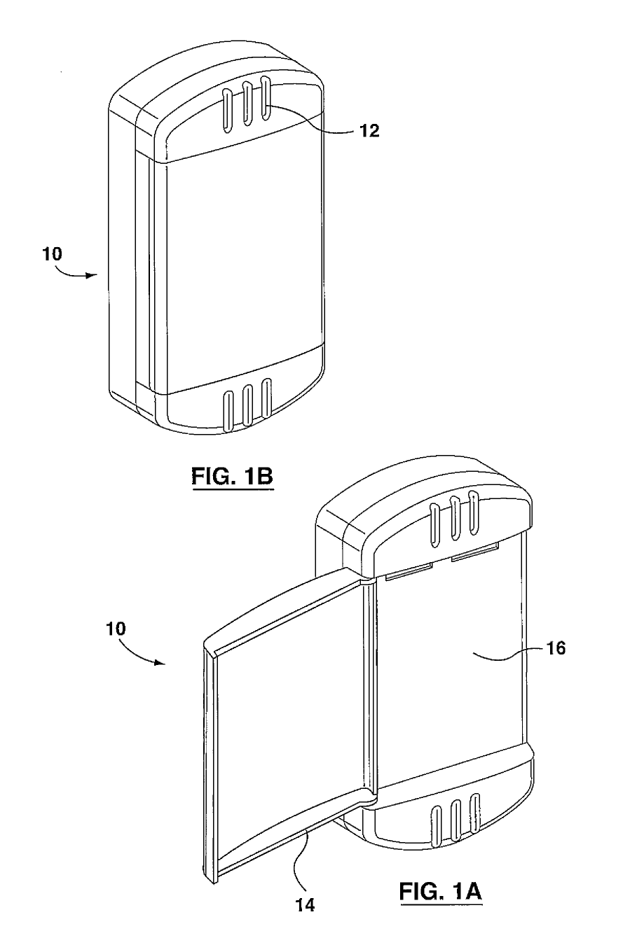

As shown in FIG. 1A the base unit 10 may include a housing formed of a suitable material, such as plastic, or a material that is durable and may be weather resistant. The sound detection means may be located within the base unit. Slots 12 may be formed in the base unit to assist with the ability of the sound detection means to detect sound occurring outside the base unit. For example, the base unit may be removeably attached to a building, or located near a building, and the sound detection means may detect sounds within the range of the sound detection means, such as footsteps, cars driving, doors opening or closing, windows opening or closing, breaking glass, knocking on a door or other part of a building, or any other sounds occurring near the base unit. The sounds that are detectable by the sound detection means may vary in accordance with the strength of the sound detection means and/or the settings of the sound detection means (meaning whether it is set to detect a wide range of noises, or to detect a limited range of noises).

Settings for the sound detection means, and the comparator, may be stored in the base controller, which may be a microcontroller, in a broadcasting device as a broadcasting controller, or in another storage area accessible by the system. As described herein, a user may set certain settings to be utilized by the sound detection means, such as the reference sound level, time periods of reference sound levels, or other settings. These user inputted settings may be stored and applied by the base controller, or by another element of the system, depending on the configuration of the system.

As shown in FIG. 1B, embodiments of the base unit of the present invention may incorporate a hinged cover section 14. The hinged cover section may have several uses. For example, an interior section 16 may include an input means, such as a keyboard, or a display means (not shown). The hinged cover section may provide access to the interior section when the hinged cover section is open, and may further provide protection for the interior section when the hinged cover section is closed. The hinged cover section may incorporate features, for example, such as an input means or a display means either on the inner and/or outer portions of the hinged cover section. The hinged cover section may be lockable in some embodiments of the present invention to limit access to any interior section of the base unit.

FIGS. 1A and 1B are just examples of a possible base unit that may be an element of the present invention. A skilled reader will recognize that the look, shape and features of the base unit may vary for different embodiments of the present invention. For example, the base unit may incorporate a keyboard, either on the outer face of the base unit, or as part of an interior section of the base unit. In a base unit that incorporates a keyboard, the keyboard may be a means of inputting information to the system, such as, for example turning the system on or off, or inputting other information as described herein.

Embodiments of the present invention may further include a base unit that incorporates a display means, for example, such as a screen. The display means may display information generated by the system or inputted into the system, such as, for example displaying input information received from entry on the keyboard, displaying messages indicating the status of the system (such as a loss of power, a triggered device, etc.), or any other information relating to the system. A skilled reader will recognize the types of information that may be displayed on the display means of the present invention.

The base unit may function and communicate with a sound detection means. The sound detection means may include a sensor operable to detect sounds. The sensor may be contained in the base unit, or may positioned remotely from the base unit and be connected to the base unit by wires, or wirelessly. The sensor of the present invention may comprise a microphone, or other device operable to detect noise.

The system of the present invention may further include a comparator device operable to compare the detected noise level to one or more reference levels. The reference level may be a sound level range or a specific sound level. The result of the operation of the comparator device may be to produce a determination as to whether the detected noise is likely created by a potential intruder. For example, should the detected noise meet or exceed the reference level the sound may be identified as likely to indicate the presence of a potential intruder. Upon the comparator determining that a noise exceeds the reference level this determination may be communicated to the base controller. The base controller may transmit at least one signal to a broadcasting device, or other remote element or device connected to the present invention operable to provide an alarm response (such as a light, a siren, a cellular phone, or other alarm response element or device).

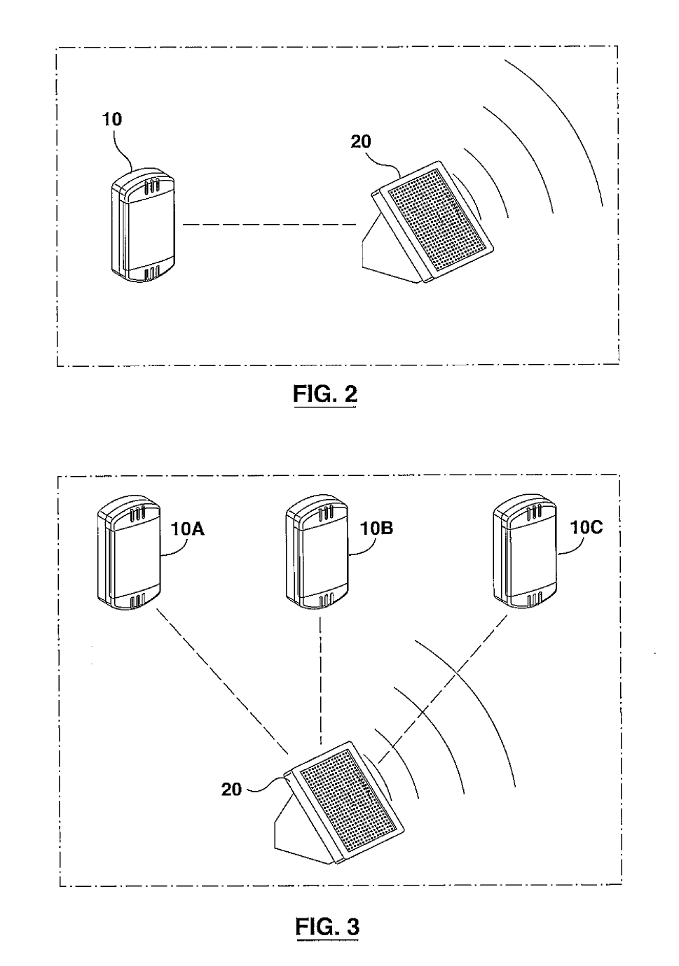

As shown in FIG. 2, a signal transmitted by a base controller 10 may be received by a broadcasting device, such as a speaker 20 or other device capable of broadcasting a recorded sound. Upon receipt of the signal the speaker or other broadcasting device may activate one of a plurality of sound recordings of different dog sounds and broadcast the sounds through the speakers.

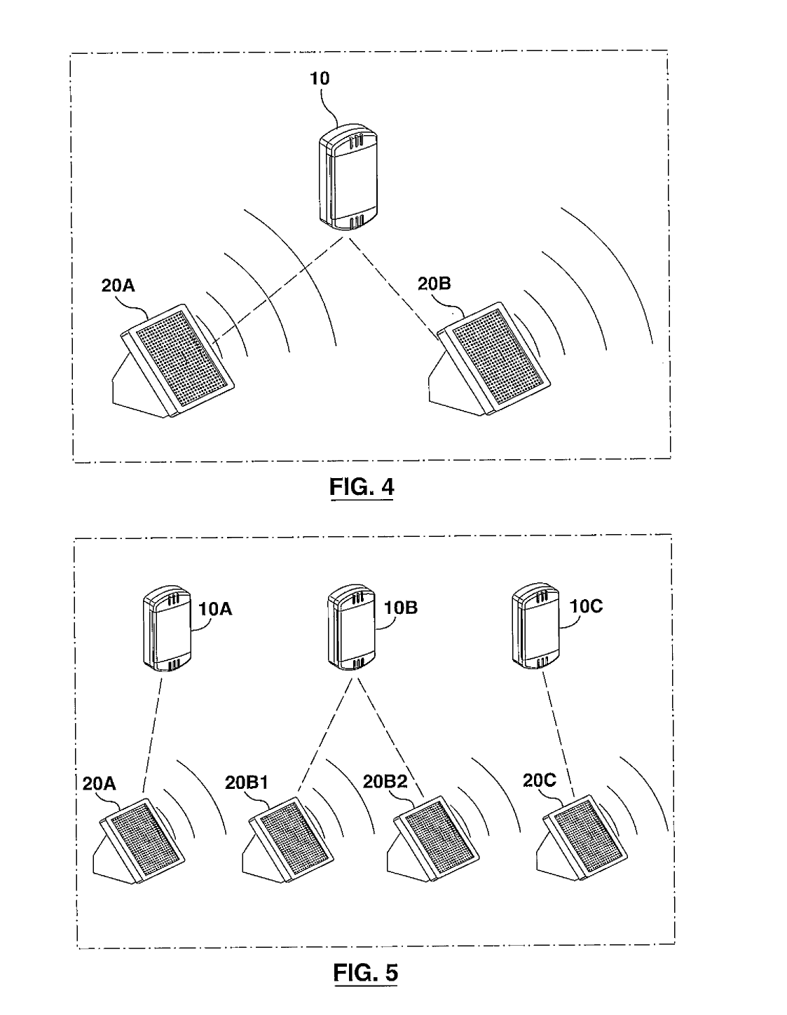

As shown in FIG. 3, multiple base units may each be operable to transmit a signal to the same speaker. Additionally, as shown in FIG. 4, one base unit may be operable to transmit signals to multiple speakers. A skilled reader will recognize the various configurations of base units and speakers that may be incorporated in the system of the present invention.

The sound recording may be broadcast for a specific period of time. The time of the sound recording broadcast may be the full length of the sound recording, or may be some shorter period of time. The time of the broadcast may be set by the user. Each broadcasting device may include a broadcast controller, such as a microcontroller, and the broadcasting controller may store one or more broadcast settings and may use these to control the broadcast of the broadcasting device. Alternatively, the base controller may control the broadcast of the broadcasting device by sending specific instructions by way of the signal communication to the broadcasting device.

The sound recording may include any combination of sounds or effects. For example, a sound recording may include the sound of multiple dogs barking, or one dog barking, or other dog sounds, such as, for example, growling, footsteps, scratching on a surface, or other sounds. The sound recording may include fading, so that the dog sounds increase and decrease in intensity during the broadcast, so as to provide the effect of a dog moving within the building. The sound recording may be chosen by the user. The level at which the sound recording may be broadcast may also be set by the user. Settings chosen by the user may be in accordance with particular periods of time (e.g., the time of day, a date, particular dates, or a combination of these), and such settings may increase the effectiveness of the system as a deterrent to potential intruders.

The speakers may be integrated in the base unit, or may be one or more stand alone speakers, or a combination of speakers types.

In one embodiment of the present invention the broadcasting device(s) may be, or may include, a portable speaker that is a size and shape that is easily carried by, or with, a person. This portable speaker may cause the dog sounds to be broadcast from the speaker while it is carried by a person and is within range to receive a signal transmitted by the base unit. It may be possible for the portable speaker to be in the form of a unit that is attachable to a person's clothing or a unit that may be worn around a person's neck. Use of the portable speaker may cause an intruder either to abandon an attempt to break into the building, or at least to avoid the area in the building where the person is located, due to fear of a dog. As a consequence the person may be able to call for help or escape the building.

In one embodiment of the present invention a speaker may be included in a key fob or other device. The key fob or other device may therefore be dual-purpose in that it may provide a speaker and also be used as an information entry means device in conjunction with the present invention, for example, such as to activate or program the present invention as described herein.

Stand alone speakers or other broadcasting devices may be positioned virtually anywhere in the building where the speaker or broadcasting device is operable to receive a signal transmitted by the base unit. The base unit may be operable to transmit signals to one or more speakers or broadcasting devices simultaneously, or virtually simultaneously. The base unit may further be programmed to transmit signals to specific speakers or broadcasting devices, and these specific speakers may be chosen in accordance with a variety of criteria, such as a period of time (e.g., time of day, date(s), or combination), the level of noise around a building, etc.

The positions of the speakers or broadcasting devices within a building may be chosen to create a specific effect when recorded sounds are broadcast through the speakers or broadcasting devices. For example, the position of the speakers or broadcasting devices may create the illusion of multiple dogs within a building, of one or more dogs moving within the building, or other sound-based illusions that may include illusions the would cause a person hearing the broadcast recordings to assume one or more live dogs exist within the building. A skilled reader will recognize that a wide variety of positions of the speakers, and combinations of recordings, may be applied in the present invention. A skilled reader may further recognize the illusions that these may create of one or more live dogs within a building, and the deterrent that the broadcast recordings may present to a potential intruder.

The base unit may further include a real-time-clock that may be in communication with the base controller and may be used to increase/decrease the sensitivity of the system of the present invention at certain times during the day, or during a period when the user is away from building. For example, if during the day the building is close to a busy street then the base unit (and more specifically the base controller, the sound detection means, and/or the comparator) may be programmed to detect noises that are louder than the street sounds as possible threats, whereas at night when the street sounds are diminished the base unit and related elements may be programmed to detect noises, that are at a lower volume than the noises it detects as possible threats during the day, as possible threats during the night hours. In this example, the reference sound level may be set to a higher/louder noise level during the day and to a lower/quieter noise level during the nighttime. In embodiments of the present invention it may be possible to increase or decrease the sensitivity of the system at any combination of time periods. Additionally, it may be possible to set the sensitivity of the system on the fly, for example, to increase the volume required to be detected as a possible intruder during a particular period of time when a lot of noise will be occurring in or around a building, such as during construction occurring for a few hours in or near the building.

In one embodiment, the present invention may include at least one transceiver whereby information, communication, and/or signals may be transmitted and received. In an embodiment of the present invention the transceiver may be operable in a bi-directional manner. For example, signals may be sent by the base unit upon a trigger, such as detection of noise that exceeds the reference level, and a verification may be returned by the broadcasting device that received the signal from the base unit to the base unit indicating that a response to the signal has been performed. As another example, when information is input to the system, such as by a remote device or through direct entry by way of keyboard attached to the base unit, verification of receipt of that information may be received by the base unit.

Any verification of received input may further be indicated to a user of the system. For example, the verification may appear as a message on a screen included in the base unit. Verification may further be sent as a message to a person remote from the building, for example, by a telephone message, text message or email, in a manner similar to the one described below. In one circumstance verification sent as a message may be sent subsequent to the message indicating that the system has been triggered by the noise of a potential intruder. The verification message may state that based on the trigger the sound recording is being broadcast and thereby verify that the system is functioning. Verification may also be indicated through any other means, such as a beep, buzzer, or a flash of light on a key fob, base unit, or other device that may be used as an information input means. A skilled reader will recognize the wide variety of means whereby verification may be received and then indicated to a user of the system.

The base unit may include an information entry means or an input means, whereby a user can enter information to be received by the system. The information entry means may be a keypad or another permanent, detachable or remote wirelessly connected unit, such as a detachable keyboard, or a communication means whereby information may be inputted in a computerized device and transmitted to the system. For example, a wireless information entry means may include a smart phone wherein information may be inputted and transferred to the system, or another computerized device operable to transmit information to the system.

Information may be inputted as text, by pressing of buttons that have a specific purpose (such as, for example an “ON” button), or by pressing a combination of buttons that indicate a specific activity (such as, for example, pressing a button twice, or another variation of multiple times, to indicate that the system should be delayed).

As another example, as shown in FIG. 6, a wireless remote information entry or other portable device means may be a key fob 30, specifically configured to operate with the system. The key fob may incorporate a confirmation means, whereby the transfer of a signal or command from the key fob to the base unit may be confirmed, for example, such as a light 32 which may flash when a signal is sent from the key fob to the base unit. In some embodiments the key fob may include buttons to activate certain functions of the base unit, for example, a button to turn the system on, a button to turn the system off, a delay button, a panic button, or other buttons. Alternatively, the key fob may respond to the pressing of one or more buttons integrated in the key fob in a particular sequence. For example, pressing a button once may indicate turning the system on, whereas pressing a button twice in quick succession may indicate turning the system off, etc. A skilled reader will recognize the variety of means of generating particular signals or communications to be sent to the system of the present invention.

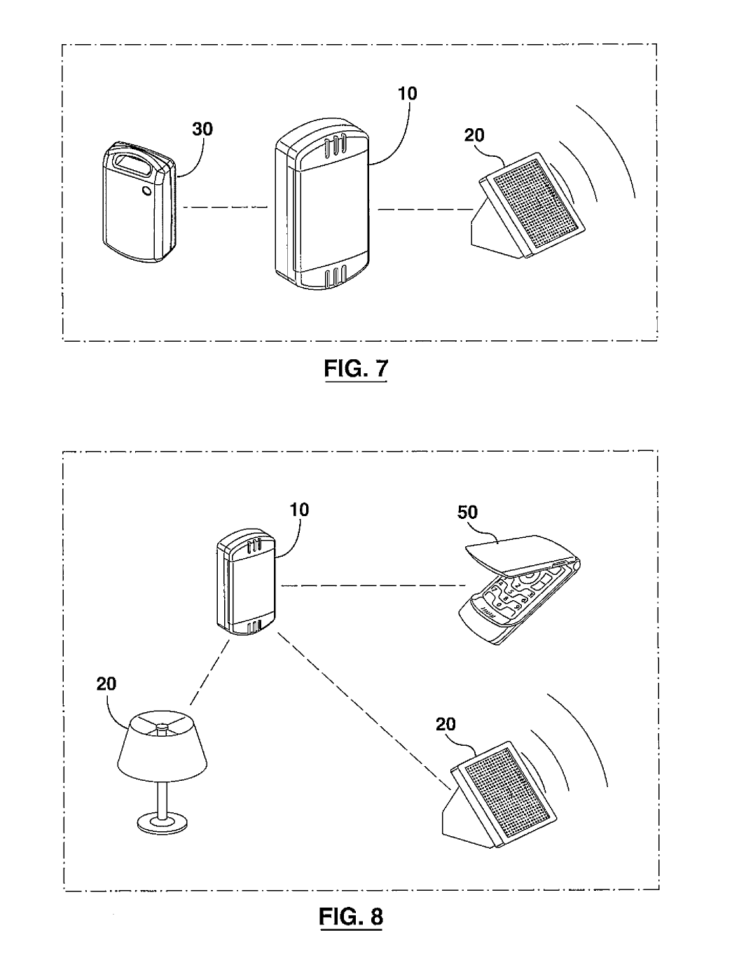

In one embodiment of the present invention, the key fob 30 may be used to activate or deactivate the system or part of the system. As shown in FIG. 7, a signal or command may be transmitted from the key fob 30 to a base unit 10, and this signal or command may be to turn on or off the base unit. Once turned on the base unit may function as described herein to transmit a signal to a speaker 20 which may cause the speaker to emit sound, such as dog barking sounds. The signal or command from the key fob to the base unit may also be operable to cause the base unit to transmit a signal to the speaker that causes the speaker to immediately begin to emit sound, as described herein. These are just a few possible examples of the operation of the key fob in the present invention. A skilled reader will recognize that the key fob may be used for a variety of other purposes.

As further examples, the key fob or other portable device configured to function with the system (such as an information input means that may be a tablet, a cellular phone, a smart phone, or other device) may be used to turn on the one or more base units in the building remotely. For example, the key fob or other portable device may be utilized to turn on the system as a person is leaving the building. When the system is turned on it is operable to detect noise and activate or trigger one or more alarm responses, as described herein.

The key fob or other portable device configured to function with the system, may be used to turn off the one or more base units, so that the one or more base units stop detecting noises and therefore are unable to activate or trigger any alarm response. For example, a user may use the key fob or other portable device to turn off one or more base units when the user is arriving at the building or entering the building.

In embodiments of the present invention that include multiple base units it may be possible to turn all of the base units off or on, or to turn a pre-selected collection of base units on or off, by way of a single command to the system from a key fob, portable device, or through direct input into a base unit of the system. Alternatively, individual base units may be turned off or on through interaction with each individual base unit.

The key fob or other portable device may also be operable to initiate an alert or panic function, whereby a signal or command is sent to the base unit to cause the speakers to emit sound immediately. The alert function may be initiated based upon a user seeing someone lurking near the building, or some other suspicious activity that the user witnesses which will not set off the alarm. Causing an alarm response to be triggered or activating by utilizing the panic or alert function may end or avert suspicious activity because causing one or more alarm responses to occur may act as a deterrent.

The key fob or other portable device, may initiate a delay function for one or more, or all, activities of the system. The delay may be for a pre-programmed time period, or may be set for a specific time period when the delay is entered in the system. For example, a delay may be set to allow a user to turn the system on and have the delay time to physically leave the building. The delay feature may further be applied through direct input by a user to the system through an input means integrated in the base unit.

The key fob, other portable device, or information input means may be used to cause a signal sent to the base unit, or one or more alarm responses, to be delayed, or not to be sent to a particular destination, either continuously, on an intermittent basis or for a specific event. For example, each time the key fob is used to turn the system off, this command may occur with a delay. A skilled reader will recognize that many variations may be incorporated in particular commands to be received by the base unit, or activated or triggered by the base unit.

A skilled reader will recognize that the key fob, portable device, or other information input means may be utilized to transfer other information, signals, communication, and/or settings to the system.

The information entry means may allow the user to input information, communication, instructions, or generate signals, to be used by the system. For example, the information may include the reference noise level setting(s), including specific reference noise levels corresponding to periods of time, such as hours during a day, or dates, or other information, communication, instructions or signals. The information entry means may be used to alter settings of the system, or to affect the function of the system (e.g., turn the system on or off, etc., as described herein).

The system may include a selection of specific recordings of dog barks or other sounds that may be broadcast through the speakers. The selection of recordings or other media may be stored in the base unit, the speakers or other broadcasting device, or in a remote device that is accessible by the system. The dog barks or other sounds or media may be set to be triggered or activated for broadcast in a variety of ways, as described herein. For example, such as: in accordance with the specifications of a particular speaker that is to broadcast the recording; sensitivity to the level of noise detected by the sound detection means; the order of speaker broadcasting of sounds if multiple speakers are to broadcast sounds; etc. The length of the broadcast may also be set by the user. The user may set the dog bark recordings to alternate between dog bark recordings broadcast on a speaker. The user may also utilize select sound recordings that come with the system, or upload other pre-recorded sounds to the system. One embodiment of the present invention may further provide a means of recording sounds directly to the system.

A variety of sounds may be included on particular memory cards. One or more memory cards may be utilized in the present invention to access a variety of sounds. The one or more memory cards may be changed and replaced by other memory cards with new sounds. Changing or alternating memory cards may have the effect that the same sound will not be heard upon an intruder attempting to enter a building multiple times. This may cause an intruder or other persons hearing the alarm sound to believe that different people and/or animals are inside the building each time, and that it is not possible to break into the building at any point in time without detection.

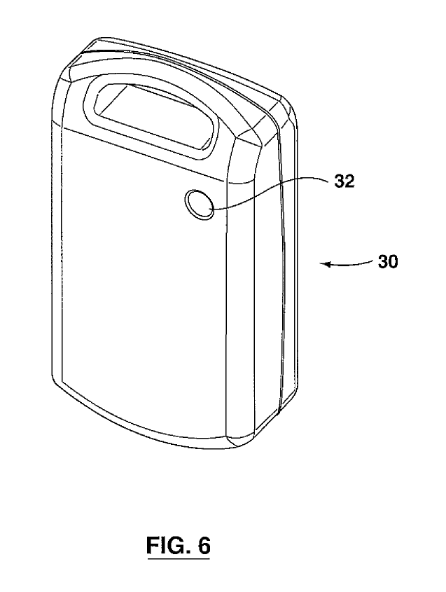

Embodiments of the present invention as shown in FIG. 5, may include multiple base units and multiple broadcasting devices that may be speakers. The base units and speakers may be configured to operate in conjunction with each other to create a specific effect that may deter possible intruders. For example, the effect created by the one or more speakers may be one or more live dogs existing within a building.

The multiple base units may function in the system so that each base unit may detect sound at a specific area of a building, such as one base unit detecting noise at a back door of a building, one base unit detecting noise at a front door of a building, one base unit detecting noise near a window, etc. The base units may be placed at locations where an intruder may be likely to attempt to gain access to a building, or at other locations. Thus, the locations of the base units may be strategically chosen, or be chosen for other reasons.

In this manner several locations within or outside a building (e.g., doors, windows, etc.) may be monitored for sound of a potential intruder, in accordance with the position of the multiple units.

The sound that is broadcast by speakers that are related to various base units may differ. For example, using the embodiment of the invention shown in FIG. 5 as an example, a speaker 20A may broadcast the sound of a German Sheppard, while speaker 20B1 may broadcast the sound of a Doberman. The system may by this means provide the effect of multiple dogs being located at various locations within a building. This effect may increase the deterrent that the system presents to a potential intruder.

In an embodiment of the present invention that includes multiple base units and speakers, as shown in FIG. 5, the speakers may be positioned so that if one base unit (e.g., base unit 10B) detects sounds that exceed the reference level for that particular base unit 10B, that a signal is sent to one or more speakers (e.g., speakers 20B1 and 20B2). At least one of the speakers 20B1 or 20B2, may be positioned close to another base unit (e.g., 10C). In this configuration the recording broadcast from at least one of speakers 20B1 or 20B2, may cause base unit 10C to detect the broadcast recording as a sound that exceeds the reference level for base unit 10C. This may cause base unit 10C to send a signal to the one or more speakers (e.g., 20C) that correspond with base unit 10C, and thereby cause the broadcast of a recording from speaker 20C. A skilled reader will recognize the variety of options and effects that may be created by the inclusion of multiple base units and/or multiple speakers in the present invention.

In an embodiment of the present invention incorporating multiple base units, the base units and related broadcasting devices may be positioned to trigger or activate each other. This may create a result whereby the multiple speakers of multiple units may be configured to broadcast recordings that create a specific effect collectively. In such a configuration the multiple base units and broadcasting devices, such as speakers, may be individually controlled or a main controller may be included in the system to control all of the base units and related broadcasting devices of the system.

An embodiment of the present invention that includes multiple units may function to create several effects by way of broadcasting sound recordings. For example, the effect may be: the illusion of a dog moving within the building; a great burst of sound throughout a building; the illusion of multiple live dogs within a building (e.g., one possibility is broadcast recordings that collectively act so that the sound mirrors the activity of live dogs, whereby the barking of one in one part of the building would naturally trigger the barking of one or more dogs in other parts of the building); or other illusions of activities of one more dogs within a building that may deter a potential intruder. The sound recordings may also include noises that may accompany movement of one or more dogs in the buildings, such as the sound of a dog scrambling to its feet, furniture being knocked over, a mat sliding as a dog gets to its feet, or other noises that may accompany one or more dogs being alerted to a potential intruder. A skilled reader will recognize the wide variety of effects that may be achieved through the sound recordings and the variety of types of sounds that may be utilized to achieve different effects.

Still another embodiment of the present invention that includes multiple base units may function so that if the speaker(s) (e.g., 20A) corresponding to one base unit (e.g., 10A) are triggered or activated the speakers corresponding to another base unit (e.g., speaker 20B1 corresponding to base unit 10B) will not broadcast any sound recording. In this manner the present invention may be configured so that various base units may be triggered or activated, or not triggered or activated, if another base unit is triggered or activated. A skilled reader will recognize the variety of configurations of base units and corresponding trigger or activation settings that may be possible in the present invention.

Another embodiment of the present invention may include other elements or devices that could be utilized to create alarm responses, and thereby increase the deterrent effect and overall effectiveness of the system. Such an embodiment is shown in FIG. 8, which shows that the base unit may transfer signals or commands to multiple devices, including: a signal for a light to turn on; a signal for a speaker to emit sounds; and an intruder warning communication to a cellular phone. A skilled reader will recognize the variety of elements and devices that may be integrated with the present invention and the configurations of the invention that may incorporate one or more elements and/or devices.

As an example of an embodiment of the present invention that includes other elements that are utilized to evoke alarm responses, one or more lights could be connected to the system of the present invention. The one or more lights may be triggered or activated to turn on based upon a signal that is sent from the base unit when a sound that exceeds the reference level is determined. The lights could be connected to the base unit by a wire, or be wirelessly connected. The lights may be positioned in various locations within a building. For example, the light that turns on may be an interior light, such as would be turned on by a person inside the building upon hearing the barking of a dog. As another example, the lights may be exterior lights that would light the premises and thereby potentially light the location of the potential intruder. Strobe lights, flashing lights, coloured lights, or other types of lights, in isolation or combination, could also be integrated with the present invention. As still another example, the lights could be positioned in internal and external locations.

Additionally, in a multi-unit embodiment of the present invention, lights may be connected to individual base units. For example, when a first base unit is triggered or activated a lamp inside the building may turn on. As other base units are triggered or activated other interior or exterior lights may turn on. The lights may give the effect of a person inside the building making his or her way to another point in the building in relation to the place where sound was detected. The lights may also produce an effect whereby a person appears to be following the sound of the dog(s) barks.

A skilled reader will recognize that a variety of effects and illusions may be created through the inclusion of lights and sounds in embodiments of the present invention.

In yet another embodiment of the invention, other devices may be integrated with the system to function to deliver alarm responses to deter a potential intruder. Such other devices may include a siren, another alarm sound, or an alarm device, for example, such as a warning sign, etc. The noise of a siren, or another alarm sound, may be triggered or activated to sound simultaneously, or virtually simultaneously with the sound of the broadcast recording of a dog barking, or before or after the broadcast of the recording. The siren, other alarm sound, or alarm device, may be connected to the base unit by wires, or may be wirelessly integrated with the system. A skilled reader will further recognize the variety of configurations by which multiple added deterrent elements may be incorporated in embodiments of the present invention.

An embodiment of the present invention may further be operable to send intruder warnings, or requests for assistance to portable devices of one or more persons who may be remote from the building where the base unit is positioned. The present invention may send a message to a remote device as an alarm response. The messages sent to a remote device may include voicemail to a phone, a text to an electronic device (such as a computer, tablet, smart phone or other mobile device), or an email message to an electronic device. For example, an embodiment of the present invention may be operable when it is activated or triggered (such as by the detection of a noise that exceeds the reference sound level by the sound detection means) to call one or more specific telephone numbers to connect with a telephone, a cellular phone, or a smart phone, or send an email or text message to a computerized device, such as a laptop, tablet, cellular phone, Blackberry, iPhone, smart phone or other computerized device. The system may contact a neighbour, the owner of the building, a security company, or any other party through this means to alert the contacted person to the threat to the building posed by a potential intruder.

In embodiments of the present invention that allow for a message to be sent by the system one or more specific messages may be hardcoded into the system to be sent by the system. The messages may be audio and/or text messages. Such messages may be sent in accordance with the level of sound that is determined by the comparator device in relation to the reference level, or other criteria. For example, the messages may be increasingly dire in accordance with louder noises being detected by the base unit. Louder noises may indicate a greater threat to the building from a potential intruder. For example, noise indicating that someone is near the building may be of a lesser level than noise of a window breaking. A series of noise levels and corresponding messages may be included in the system. These may be set for specific periods of time, as described herein. The system may send out one or more specific messages based upon the level of sound detected by the base unit.

The one or more messages to be sent, the level of sound that the messages will be sent at, and the recipients of the messages may be hardcoded into the system, or may be selected by the user. In some embodiments specific information may be included in a message as appropriate to the actual sending of a message, such as the time of day. The keypad or other information input means of the present invention may be utilized to specify and/or select messages, set time periods and/or sound levels corresponding to messages, as well as to turn the message option on or off.

The system may send out multiple messages to the same device as the noise detected increases and meets particular levels. The system may send out multiple messages to multiple devices simultaneously, or virtually simultaneously. Additionally, the number and destination of messages sent by the system may vary in accordance with the level of the noise detected, for example, such that a low level of noise may trigger a message to be sent to the owner of the building warning that a potential intruder has been detected, whereas a higher level of noise may trigger messages being sent to the owner of the building, as well as a neighbour and/or a security company warning that a potential intruder may be trying the break into the building. A skilled reader will recognize that the types of messages, the noise levels set for sending messages, the message content, and the variety of recipients of message may vary in embodiments of the present invention.

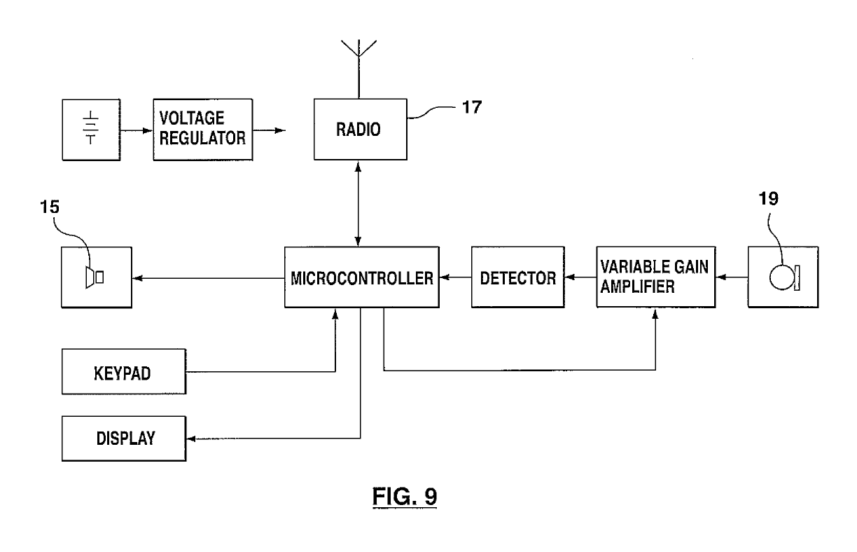

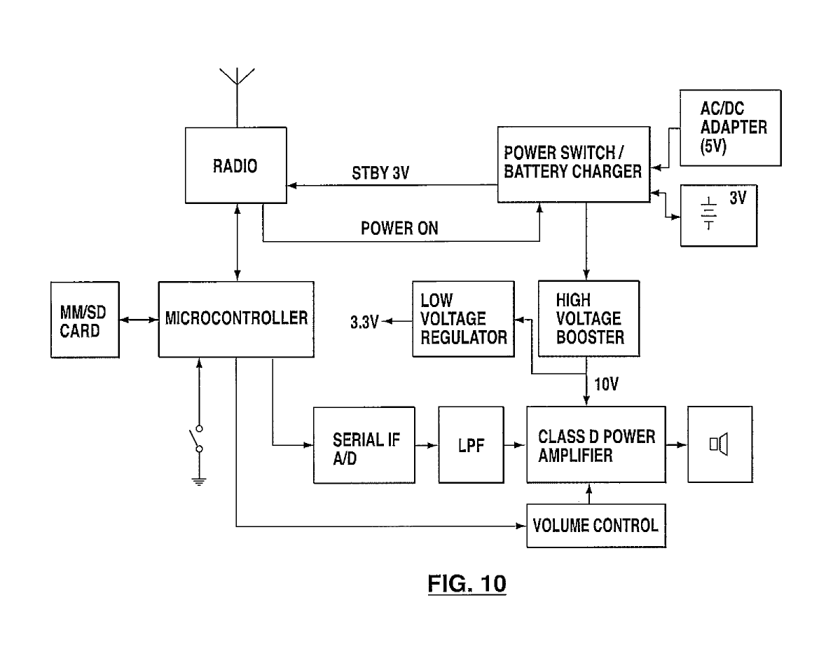

In one embodiment of the present invention the base unit may be configured to include the circuitry of FIG. 9. A skilled reader will recognize that other embodiments of the present invention may be configured to include other circuitry.

One embodiment of the present invention may be powered by either a battery pack. The present invention may alternatively be connected to a power source, such as by way of a plug connection to a power outlet, or through hardwiring into a power source. In one embodiment of the present invention the base unit may include for four AA batteries and said batteries may be used to power the base unit. The base unit of this embodiment may further include an AC adaptor that can be connected to a power source as an optional means of powering the base unit.

The base unit may incorporate a malfunction indicator 15, such as a buzzer or a flashing light. The malfunction indicator may be activated if the base unit is malfunctioning or anticipating a malfunction, for example, such as when a low battery is detected, or some other immediate or imminent function failure is detected. Activation of the malfunction indicator may act to alert a user to the immediate or imminent function failure of the base unit or the system generally.

As described above, the sound detection means may be directly or wirelessly connected to the base unit. The sound detection means may include a microphone 19. The microphone may detect sounds and capture a detected sound level for that sound. The sound detection means may be connected to a comparator. The comparator may compare a detected sound level to a reference sound level. A base controller, that may be a microprocessor in some embodiments of the present invention, may be used to set the sound level to be used by the comparator, in any of the manners described herein. The base controller may be programmed to cause the comparator to apply a different reference sound level depending on the specific time period when the sound detection means is functioning. For example, as described herein, the reference sound level utilized by the comparator may be set to a lower level during nighttime hours than during daytime hours. If the comparator identifies that the detected sound level is equal to or greater than the reference sound level then the sound detection means activates the transmission of a signal to a broadcasting device or other device or element operable to produce an alarm response.

To generate the transmission of a signal, the base unit may further include a base transceiver 17. The base transceiver may be bi-directional. The base transceiver may be operable to function with a wireless interface and/or a base unit controller. Generally the wireless interface may be used to facilitate wireless transmissions to and from the base transceiver whereas the controller may be used to facilitate transmissions to and from the base transceiver involving wired elements or devices.

An embodiment of the present invention may also be a wired system, and in such a system a transceiver may not be required.

One such device that may receive a signal transmitted from the base unit, may be one or more speakers. The one or more speakers of the present invention may be powered by a battery or may be connected to a constant power source, such as by way of a plug connection to a power outlet, or through hardwiring into a power source. For example, in one embodiment of the present invention the one or more speakers may be connected to two DD batteries, and may include an external AC adaptor plug. A malfunction indicator may be incorporated in the speakers, and may be similar to that described for the base unit.

FIG. 9 shows the circuitry of one possible embodiment of the present invention, although a skilled reader will recognize that other circuitry configurations may also be possible. The circuitry of an embodiment of the present invention may include a broadcasting transceiver 26 that is operable to receive the signal transmitted from the base unit. The circuitry may further incorporate a broadcasting controller 22, that may be a microprocessor, that is provided to control the operation of the circuit. Upon receipt of a signal the broadcasting controller 22 may be activated to read an SD memory card 24 that has multiple sound recordings, such as sounds of dog barks, stored thereon. Depending on the settings of the system the broadcasting controller may be activated to read the SD memory card to do any of the following: select and play a specific dog bark; or select and play a sequence of dog barks. The selected dog bark(s) may be emitted through the speakers at a pre-selected volume, so that the sound of dog bark(s) is audible as coming from the location of the speaker.

Generally, in some embodiments of the present invention, one or more of the speakers may include a bi-directional broadcasting transceiver. The broadcasting transceiver may be operable with the broadcasting controller to generate and transmit a signal to another element or device of the invention, such as an element or device operable to produce an alarm response, upon a trigger or activation signal received by the broadcasting transceiver. For example, upon receipt of a signal from the base unit the speakers may select and play dog bark(s). In one embodiment of the present invention a speaker may be operable to generate a signal or other communication to cause other elements or devices of the system, or that are linked to the system, to be turned on, such as a light or a siren. The speaker may include a button whereby it may be paired or unpaired with the other elements or devices.

In embodiments of the present invention that include a key fob, the key fob may include a transceiver. The transceiver may generate and send signals to the base unit for the purposes discussed above, for example, such as turning the alarm system on or off, and other functions of the key fob.

In embodiments of the present invention, custom firmware may provide virtually error-free communication between elements of the system, as well as virtually error-free operation of the system generally.

It will be appreciated by those skilled in the art that other variations of the embodiments described herein may also be practiced without departing from the scope of the invention. Other modifications are therefore possible. The present invention may be used as a warning system based on noises for other purposes than warning of a potential intruder. For example, the noise detectors could detect sounds such as thunder and send a warning communication to a user, such as by way of a cellular phone message, so that a building owner will know to come to the building and shut the windows. A skilled reader will recognize that warnings based on noise levels, as provided by the present invention, could be useful in a variety of situations.

What is claimed is:

1. An alarm system, comprising:
(a) a noise detection means operable to detect one or more noises;
(b) at least one comparator operable to compare the detected one or more noises to a reference sound level and determine if the one or more noises are equal to or exceed the reference sound level;
(c) at least one base transceiver operable to transmit one or more signals to one or more alarm response devices if the comparator determines the one or more noises are equal to or exceed the reference sound level, said base transceiver transmitting the one or more signals wirelessly or through a wired connection; and
(d) the one or more alarm response devices each being operable to produce an alarm response.

2. The alarm system of claim 1, further comprising the noise detection means incorporating a microphone operable to detect the one or more noises.

3. The alarm system of claim 1, further comprising one or more base units that house one or more of the base transceiver, the noise detection means and the comparator, said base unit being attachable to a building or other structure.

4. The alarm system of claim 1, further comprising the base transceiver that is a bi-directional transceiver.

5. The alarm system of claim 1, further comprising the one or more alarm response devices including one or more of the following:
(a) one or more broadcasting devices that emit one or more media when the one or more signals are transmitted by the base transceiver;
(b) a light that is turned on when the one or more signals are transmitted by the base transceiver;
(c) a siren that sounds when the one or more signals are transmitted by the base transceiver; and
(d) an electronic device that receives a message when the one or more signals are transmitted by the base transceiver.

6. The alarm system of claim 5, further comprising at least one of the one or more broadcasting devices that are one or more speakers, said one or more speakers being operable to emit at least one of the one or more media that is one or more sound recordings.

7. The alarm system of claim 6, further comprising at least one of the one or more sound recordings being dog barking sounds.

8. The alarm system of claim 1, further comprising at least one of the one or more alarm response devices incorporating a broadcasting transceiver that is operable to transmit a signal to at least one of the one or more alarm response devices, said at least one of the one or more alarm response devices performing an alarm response in response to said signal from the broadcasting transceiver.

9. The alarm system of claim 8, further comprising the broadcasting transceiver being a bi-directional transceiver.

10. The alarm system of claim 1, further comprising one or more information input means linked to the alarm system, said information input means being operable to be utilized by a user to communicate or input one or more system settings into a base controller of the alarm system, whereby the base controller controls the alarm system in accordance with the system settings.

11. The alarm system of claim 1, further comprising a key fob operable to do one of the following: turn the alarm system on; turn the alarm system off; cause the base transceiver to transmit the one or more signals to produce the one or more alarm responses.

12. A method of producing one or more alarm responses by one or more alarm response devices, comprising the steps of:
(a) a noise detection means linked to a base unit detecting a noise;
(b) a comparator contained in the base unit comparing the detected noise to a reference sound level;
(c) a base transceiver contained in the base unit transmitting one or more signals to at least one of the one or more alarm response devices when the comparator determines that the detected noise is equal to or exceeds the reference sound level; and
(d) the at least one of the one or more alarm response devices receiving the one or more signals and producing the one or more alarm responses in response to receipt of the one or more signals.

13. The method of claim 12, further comprising the one or more alarm response devices performing one or more of the following steps as the one or more alarm responses:
(a) at least one of the one or more alarm response devices being one or more broadcasting devices, said one or more broadcasting devices emitting one or more media when the one or more signals are transmitted by the base transceiver;
(b) at least one of the one or more alarm response devices being one or more lights, said one or more lights turning on and lighting when the one or more signals are transmitted by the base transceiver;
(c) at least one of the one or more alarm response devices being one or more sirens, said one or more sirens sounding when the one or more signals are transmitted by the base transceiver; and
(d) at least one of the one or more alarm response devices being one or more electronic devices, said one or more electronic devices receiving a message when the one or more signals are transmitted by the base transceiver.

14. The method of claim 12, further comprising the following steps:
(a) a user inputting one or more setting by way of an input means; and
(b) a controller controlling the comparator, the base transceiver and the one or more alarm responses in accordance with the one or more settings.

15. The method of claim 14, further comprising the step of inputting settings to cause the one or more alarm response devices to produce the one or more alarm responses to be coordinated and thereby producing an intended effect.

16. The method of claim 15, further comprising the step of producing an intended effect of a live dog within a building by emitting sound recordings of one or more dogs barking through one or more alarm response devices that are one or more broadcasting devices.

17. The method of claim 12, further comprising the step of positioning the base unit near a location inside or outside a building where an intruder may attempt to gain access to the building.

18. The method of claim 12, further comprising the step of a remote device communicating with the base transceiver to produce at least one of the following steps:
(a) deactivating one or more of the noise detection means, the comparator, and the base transceiver;
(b) activating one or more of the noise detection means, the comparator, and the base transceiver;
(c) delaying one or more of the following: the producing of the one or more alarm responses by the one or more alarm response devices; deactivating one or more of the noise detection means, the comparator, and the base transceiver; or activating one or more of the noise detection means, the comparator, and the base transceiver.

19. An alarm system, comprising:
(a) two or more base units incorporating:
(i) a noise detection means operable to detect one or more noises;
(ii) at least one comparator operable to compare the detected one or more noises to a reference sound level and determine if the one or more noises are equal to or exceed the reference sound level; and
(iii) at least one base transceiver operable to transmit one or more signals to one or more alarm response devices if the comparator determines the one or more noises are equal to or exceed the reference sound level, said base transceiver transmitting the one or more signals wirelessly or through a wired connection; and
(b) the one or more alarm response devices, each of the one or more alarm response devices being associated with one of the two or more base units, and each of the one or more alarm response devices being operable to produce an alarm response.

20. The alarm system of claim 19, further comprising, one of the two or more base units being a first base unit that is operable to produce an alarm response in at least one of the associated one or more alarm response devices associated with the first base unit that is a first alarm response device, and said first alarm response device being positioned in a proximity to a second one of the two or more base units being a second base unit and the alarm response of the first alarm response device producing an alarm response that is a noise detected by the noise detection means of the second base unit as exceeding the reference sound level and said second base unit causing one or more alarm responses in the one or more alarm devices associated with the second base unit.
